(19) United States
(12) Patent Application Publication
(10) Pub. No.: US 2024/0054496 A1
(43) Pub. Date: Feb. 15, 2024

(54) SYSTEMS AND METHODS FOR PRESENTING AND ANALYZING TRANSACTION FLOWS USING A TUBE MAP FORMAT

(71) Applicant: PAYPAL, INC., San Jose, CA (US)

(72) Inventors: Jie Huang, Shanghai (CN); Gaoyuan Wang, San Jose, CA (US)

(21) Appl. No.: 17/413,286

(22) PCT Filed: Apr. 29, 2021
(86) PCT No.: PCT/CN2021/091087

§ 371 Date: Jun. 11, 2021

(51) Int. Cl. G06Q 20/40

(52) U.S. Cl. CPC G06Q 20/4016; G06Q 20/4014

(57) ABSTRACT

Methods and systems are presented for analyzing transactions conducted through user accounts with an online service provider based on a tube map structure. A transaction analysis system identifies a seed user account based on a set of risk factors, and generates a tube map based on a transaction flow originated from the seed user account. The tube map represents the transactions within the transaction flow using a multi-tier structure. The transaction analysis system disposes nodes representing different user accounts in different tiers of the tube map to illustrate when the transactions occur within the transaction flow. The transaction analysis system analyzes the transactions using the tube map to identify user accounts that likely involve in suspicious activities. One or more actions can be performed on the user accounts to improve the security of the online service provider.

### CROSS REFERENCE TO RELATED APPLICATION

The present application claims priority to PCT/CN2021/091087, filed Apr. 29, 2021, which is hereby incorporated by reference in its entirety.

### BACKGROUND

The present specification generally relates to data structures, and more specifically, to providing a data structure for efficiently analyzing electronic transactions according to various embodiments of the disclosure.

### RELATED ART

An online service provider may enable users to conduct transactions (e.g., purchase transactions, payment transactions, cryptocurrency transactions, etc.) through their user accounts with the online service provider via a transaction processing platform. Through the use of the transaction processing platform, users may conduct various types of transactions seamlessly, such as performing a purchase with a merchant, transferring funds to a friend, a vendor, etc., selling goods, and the like. While these services benefit legitimate users tremendously, malicious users may also use the transaction processing platform to conduct illegal activities. For example, malicious users may conduct money laundering activities by transferring funds through multiple user accounts with the online service provider. In order to evade detection of a source of a particular fund, malicious users may iteratively transfer the particular fund (or portions of the particular fund) to different user accounts before withdrawing the particular fund from the transaction processing platform. In certain cases, one or more portions of the particular fund may be transferred in a cyclical manner to further evade detection.

As such, the online service provider may analyze individual transactions, or a collection of transactions as a whole, to detect suspicious activities conducted through its transaction processing platform. However, as the transaction flows of funds become increasingly more complex (e.g., involving an increasing number of user accounts, an increasing number of transactions, and/or an increasing number of different types of transactions), analyzing the transaction flows has become more challenging. As such, there is a need for providing an improved way of presenting and analyzing complex transaction flow data for detection of suspicious transaction activities.

### SUMMARY

In one aspect of the disclosure, a system is presented. The system comprises a non-transitory memory; and one or more hardware processors coupled with the non-transitory memory and configured to read instructions from the non-transitory memory to cause the system to perform operations. The operations includes identifying, from a plurality of user accounts with a service provider, a first user account based on a set of risk criteria; generating a tube map for tracing funds that flowed through the first user account, wherein the tube map comprises a plurality of tiers of nodes; detecting one or more patterns corresponding to fraudulent activities based on analyzing positions of the nodes in the plurality of tiers in the tube map; identifying one or more high-risk user accounts with the service provider that are likely involved in suspicious activities based on the detecting; and performing one or more actions to the one or more high-risk user accounts. The generating the tube map comprises: disposing a seed node representing the first user account in a root tier of the plurality of tiers in the tube map, and iteratively determining a set of user accounts to which portions of the funds were transferred from one or more user accounts represented by one or more nodes in a current tier in the tube map, and disposing a set of nodes representing the set of user accounts in a subsequent tier of the plurality of tiers in the tube map.

In another aspect of the disclosure, a method is presented. The method includes: determining, by one or more hardware processors from a plurality of user accounts with a service provider, a seed user account based on a set of risk criteria; accessing, by the one or more hardware processors, a tube map corresponding to the seed user account, wherein the tube map represents a transaction flow associated with transactions originated from the seed user account, wherein the tube map comprises a plurality of tiers of nodes, and is generated by: disposing a seed node representing the seed user account in a first tier of the plurality of tiers in the tube map, and iteratively determining a set of user accounts to which funds were transferred from one or more user accounts represented by one or more nodes in a current tier in the tube map, and disposing a set of nodes representing the set of user accounts in a subsequent tier of the plurality of tiers in the tube map; analyzing relationships among nodes in different tiers within the tube map; determining one or more user accounts with the service provider that exceed a fraudulent activity threshold based on the analyzing; and performing one or more actions to the one or more user accounts.

In another aspect of the disclosure, a non-transitory machine-readable medium is presented. The non-transitory machine-readable medium stores machine-readable instructions executable to cause a machine to perform operations. The operations includes identifying, from a plurality of user accounts with a service provider, a seed user account based on a set of risk criteria; generating a tube map for tracing funds that flowed through the seed user account, wherein the tube map comprises a plurality of tiers of nodes; analyzing relationships among the nodes from different tiers of the tube map; determining risk profiles for user accounts represented by the nodes in the tube map based on the analyzing; and performing one or more actions to at least one of the user accounts represented by the nodes in the tube map based on the risk profiles. The generating the tube map comprises: disposing a seed node representing the seed user account in a root tier of the plurality of tiers in the tube map, and iteratively determining a set of user accounts to which portions of the funds were transferred from one or more user accounts represented by one or more nodes in a current tier in the tube map, and disposing a set of nodes representing the set of user accounts in a subsequent tier of the plurality of tiers in the tube map.

### BRIEF DESCRIPTION OF THE FIGURES

FIG. 1 is a block diagram illustrating a networked system that includes an electronic transaction system according to an embodiment of the present disclosure;

FIG. 2 is a block diagram illustrating a transaction analysis module according to an embodiment of the present disclosure;

FIG. 3 illustrates a conventional networked graph for representing transactions conducted through user accounts with an online service provider according to an embodiment of the present disclosure;

FIG. 4 illustrates an exemplary transaction flow using a conventional networked graph according to an embodiment of the present disclosure;

FIG. 5A illustrates an example tube map generated to represent a transaction flow according to an embodiment of the present disclosure;

FIG. 5B illustrates another example tube map generated to represent a transaction flow according to an embodiment of the present disclosure;

FIG. 6 illustrates another example tube map generated to represent a transaction flow according to an embodiment of the present disclosure;

FIG. 7 illustrates a ranking of nodes within a tube map according to an embodiment of the present disclosure;

FIG. 8 is a flowchart showing a process of generating a tube map according to an embodiment of the present disclosure;

FIG. 9 is a flowchart showing a process of analyzing a tube map according to an embodiment of the present disclosure; and

FIG. 10 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure includes methods and systems for generating and presenting an interactive graphical user interface that illustrates complex transaction flow data associated with user accounts with an online service provider. As discussed above, complex transaction flows can be challenging to trace and illustrate in a clear and useful manner. In particular, malicious users who use a transaction processing platform of an online service provider to conduct malicious activities tend to use long and complex transaction flows in an attempt to avoid detection of illegal activities. A transaction flow is defined herein as one or more series of transactions that are originated from a particular seed user account. Each series of transactions may include multiple transactions in sequence. For example, a series of transactions may include a transaction that transfers funds from a first user account to a second user account, a transaction that transfers funds from the second user account to a third user account, a transaction that transfers funds from the third user account to a fourth user account, and so forth. A series of transactions may end when funds are withdrawn from a user account, where the funds exit an environment of the online service provider (e.g., withdrawing to another banking institute external to the online service provider).

A complex transaction flow may include multiple layers of transactions—that is, each series of transactions within the transaction flows include multiple steps of transactions before the funds exit the environment of the online service provider. A complex transaction flow may also include cyclical payments where funds that were transferred out of a particular user account may subsequently be transferred back to the particular user account. For example, malicious users may use a source user account with the online service provider to distribute portions of particular funds to a first set of intermediate user accounts with the online service provider. Instead of withdrawing the portions of the particular funds from the first set of user accounts, the malicious users may use the first set of user accounts to transfer the corresponding portions of the particular funds to a second set of user accounts. The portions of the particular funds may be continued to be transferred (and/or split) among different user accounts (in one or more additional layers of transactions), before the particular funds exit the environment of the online service provider (e.g., the particular funds being withdrawn from one or more user accounts with the online service provider).

In addition to transferring the particular funds among user accounts with the online service provider multiple times, at least some portions of the particular funds may involve cyclical transactions. For example, one or more portions of the particular funds may be first transferred to a first user account. The one or more portions of the particular funds may then be transferred from the first user account to one or more other user accounts (e.g., a second user account, a third user account, etc.). After transferring the one or more portions of the particular funds to the one or more other user accounts, the one or more portions of the particular funds may be transferred back to the first user account before they are withdrawn.

Tracing and analyzing these types of complex transaction flows have been historically challenging. Conventionally, a networked graph may be used in assisting the presentation and analyzing of transaction flows. The networked graph may be constructed by generating different nodes to represent different user accounts with the online service provider. An edge may be generated between two nodes to represent a transaction conducted between two corresponding user accounts. The edge may be directional to represent a directional flow of funds associated with the transaction. Thus, a transaction that transfer funds from a first user account to a second user account may be represented by a directional edge that points from a first node representing the first user account to a second node representing the second user account.

The networked graph may be presented on a graphical user interface to illustrate one or more transaction flows within the environment of the online service provider. A human analyst or a computer system, such as a transaction analysis system, may analyze the networked graph (e.g., by traversing the nodes in the networked graph using the directional edges) to detect suspicious activities. However, as the transaction flows become increasingly more complex, it becomes increasingly challenging to analyze the transaction flows using the networked graph. For example, when many of the user accounts have been involved in both inbound (e.g., receiving payments) and outbound (e.g., transferring payments) transactions, it is challenging to trace a transaction flow associated with any one particular fund within the networked graph, as most nodes are connected to inbound and outbound edges. Furthermore, the connectedness (each node being connected with many other nodes in one or both directions) also makes it difficult to detect cyclical payments using the networked graph.

As such, according to various embodiments of the disclosure, instead of or in addition to using the networked graph as discussed above, the transaction analysis system may generate a tube map to represent one or more transaction flows conducted through user accounts with the online service provider. In some embodiments, the transaction analysis system may identify, from the user accounts with the online service provider, a seed user account based on a risk profile associated with the user accounts. In some embodiments, the transaction analysis system may identify the seed user account based on a number of transactions involved with the seed user account and/or an amount of total funds that have been passed through the seed user account. For example, the transaction analysis system may determine that a user account is a seed user account when the number of transactions (outgoing and/or incoming) within a particular period (e.g., the last six months, etc.) exceeds a threshold number of transactions and/or the total amount of funds passing through the user account within the particular period exceeds a threshold amount.

In some embodiments, the transaction analysis system may identify multiple seed user accounts when multiple user accounts have satisfied the risk criteria as discussed herein. In such instances, the transaction analysis system may generate multiple tube maps, where each tube map is generated based on a distinct seed user account. Thus, the transaction analysis system may select a first seed user account, and may generate a first tube map based on the first seed user account. The first tube map may represent a first transaction flow associated with funds originated from the first seed user account.

To generate the first tube map, the transaction analysis system may dispose a seed node representing the first seed user account in a root tier (a root layer) of the first tube map. The transaction analysis system may then determine a first set of accounts to which funds are transferred from the first seed user account (or from which funds are transferred to the first seed user account). The transaction analysis system may dispose nodes representing the first set of accounts in a first tier (a first layer) of the tube map. In some embodiments, the nodes representing the first set of accounts may be arranged in a specific order (e.g., based on account identifiers, based on time of transactions, etc.). Transactions between the first seed user account and the first set of accounts may be represented by edges (e.g., directional edges, unidirectional edges, etc.) connecting the seed node in the root tier and the first set of nodes in the first tier. The transaction analysis system may continue to trace the funds (e.g., outbound transactions) from the first set of nodes to identify user accounts in subsequent layers of the transaction flow. For example, the transaction analysis system may determine a second set of user accounts to which funds are transferred from the first set of user accounts. The transaction analysis system may dispose a second set of nodes representing the second set of user accounts in a second tier (a second layer) of the tube map. Transactions between the first set of user accounts and the second set of accounts may be represented by edges (e.g., directional edges, etc.) connecting the first set of nodes in the first tier and the second set of nodes in the second tier. The transaction analysis system may continue to add additional nodes and tiers to the tube map until the funds exit the environment of the online service provider (e.g., funds are withdrawn from one or more of the user accounts represented in the tube map). In some embodiments, the nodes representing the set of accounts in each tier may be arranged in a specific order (e.g., based on account identifiers, based on time of transactions, etc.).

In some embodiments, the transaction analysis system may generate an exit node representing withdrawal of funds from one or more user accounts. For example, when the transaction analysis system determines that a withdrawal transaction is made from a particular user account in the second set of user accounts, the transaction analysis system may connect a particular node in the second tier (that corresponds to the particular user account) to the exit node, indicating that funds have been withdrawn from the particular user account.

As discussed herein, certain transaction flows may include cyclical payments, where funds that have been transferred out from a particular user account to other user account(s) may be transferred back to the particular user account. As such, certain nodes that are disposed in different tiers in the tube map may represent the same user account. According to some embodiments, the transaction analysis system may designate those nodes that represent the same user account in higher tier(s) (e.g., the tier that is farther away from the root tier) as shadow nodes. These shadow nodes may appear differently than other nodes when presenting the first tube map in a graphical user interface such that cyclical payments within the transaction flow can be easily identified.

Once the first tube map is generated, the transaction analysis system may present, on a user device, the first tube map to illustrate the first transaction flow associated with funds originated from the first seed user account. In some embodiments, the first tube map presented on the user device is interactive. For example, the first tube map may be presented on the user device initially with only the nodes in the different tiers, without the edges. Each of the nodes on the first tube map may be selectable. Upon receiving a selection of a node, the transaction analysis system may present, on the user device, the edges that are connected to the node. Each of the edges may also be selectable, and a selection of an edge may cause the transaction analysis system to present information associated with the corresponding transaction (e.g., an amount, a date, etc.).

In some embodiments, the transaction analysis system may analyze the first transaction flow using the first tube map. For example, the transaction analysis system may determine whether any portions of the first transaction flow match a pattern corresponding to malicious activities. In some embodiments, the transaction analysis system may use the first tube map to identify user accounts that are involved in a cyclical payment. The transaction analysis system may first determine whether any shadow node exists in the first tube map. If it is determined that one or more shadow nodes exist in the first tube map, the transaction analysis system may determine that the first payment flow includes one or more cyclical transactions (where funds transferred from a particular account to one or more other user accounts are transferred back to the particular account). For each shadow node, the transaction analysis system may identify nodes that are part of a cyclical payment scheme based on traversing the first tube map forward and backward from the shadow node. Once the nodes that are part of the cyclical payment scheme are identified, the transaction analysis system may label the user account corresponding to the identified nodes as high risk user accounts. In some embodiments, the transaction analysis system may determine (or modify) risk profiles for the user accounts that are involved in a cyclical payment scheme.

In some embodiments, the transaction analysis system may use the first tube map to identify user accounts being used by malicious users for funneling funds out of the environment of the online service provider. The transaction analysis system may first locate the exit node within the first tube map, and identify a first group of nodes that are connected to the exit node. The first group of nodes that are connected to the exit node represents user accounts through which funds have been withdrawn from the environment of the online service provider. Since malicious users may use dummy user accounts for withdrawing funds to evade detection, the transaction analysis system of some embodiments may backward-trace the withdrawn funds through the identified user accounts by traversing the first tube map backward from the first group of nodes that are connected to the exit node. Based on the traversing of the first tube map, the transaction analysis system may determine a second group of nodes that provide funds to the first group of nodes for withdrawal. In some embodiments, the transaction analysis system may analyze the transactions between the second group of nodes and the first group of nodes. In some embodiments, the transaction analysis system may label one or more user accounts corresponding to the second group of nodes based on the transactions. For example, when a total transaction amount associated with one or more transactions from a user account corresponding to one of the second group of nodes to one or more user accounts corresponding to one or more of the first group of nodes exceeds a threshold amount, the transaction analysis system may label the user account corresponding to the one of the second group of nodes as a high risk user account. In some embodiments, the transaction analysis system may determine (or modify) the risk profiles for the user accounts represented by the first and/or second group of nodes.

In some embodiments, the transaction analysis system may continue to generate, present, and analyze tube maps that are based on other seed user accounts to identify high risk user accounts. Using the tube maps (instead of or in addition to the conventional networked graph), collective transactions within one or more transaction flows can be analyzed more efficiently. Thus, suspicious activities and suspicious user accounts can be detected faster than using conventional methods. Actions to protect the transaction processing platform and user accounts with the online service provider can be performed more swiftly based on the identified suspicious activities to avoid further loses or damages associated with the transaction processing platform. In some embodiments, the transaction analysis system may perform actions associated with the high risk user accounts (e.g., user accounts with risk profiles that satisfy a set of risk criteria). For example, the transaction analysis system may increase a security setting associated with the high risk user accounts, such as denying transactions conducted through the high risk user accounts, limited a number of transactions being conducted through the high risk user accounts, etc.

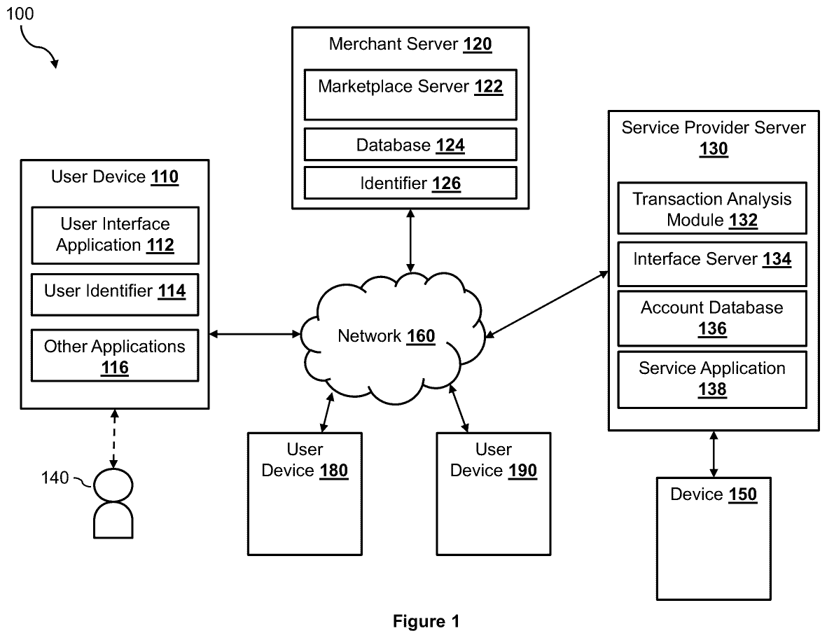

FIG. 1 illustrates a networked system 100, within which the transaction analysis system may be implemented according to one embodiment of the disclosure. Note that the present techniques may be applied in many different computing and technological environments, however, and are not limited to those shown in the figures. The networked system 100 includes a service provider server 130, a merchant server 120, user devices 110, 180 and 190 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online transaction with the merchant server 120 via websites hosted by, or mobile applications associated with, the merchant server 120. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130, and/or the merchant server 120 via the network 160. In another implementation, the user interface application 112 includes a browser module that provides a network interface to browse information available over the network 160. For example, the user interface application 112 may be implemented, in part, as a web browser to view information available over the network 160.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user 140 with a particular user account (e.g., and a particular profile) maintained by the service provider server 130.

In various implementations, the user 140 is able to input data and information into an input component (e.g., a keyboard) of the user device 110. For example, the user 140 may use the input component to interact with the UI application 112 (e.g., to retrieve content from third-party servers such as the merchant server 120, to provide inputs related to a goal to the service provider server 130, etc.).

Each of the user devices 180 and 190 may include similar hardware and software components as the user device 110 to enable their respective users to interact with the merchant server 120 and the service provider server 130 through the user devices 180 and 190. For example, the users of the user devices 110, 180, and 190 may use the respective devices to conduct electronic transactions through different user accounts of the service provider server 130.

The merchant server 120, in various embodiments, may be maintained by a business entity (or in some cases, by a partner of a business entity that processes transactions on behalf of business entity). Examples of business entities include merchants, resource information providers, utility providers, real estate management providers, social networking platforms, etc., which offer various items for viewing, accessing, and/or purchasing, and process payments for the purchases. As shown, the merchant server 120 may include a merchant database 124 for identifying available items, which may be made available to the user devices 110, 180, and 190 for viewing and purchase by the user.

The merchant server 120, in one embodiment, may include a marketplace application or server 122, which may be configured to provide information (e.g., displayable content) over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items available for access and/or purchase in the merchant database 124. The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing for electronic transactions between the users of the user devices 110, 180, and 190, and one or more merchants or other types of payees. As such, the service provider server 130 may include a service application 138, which may be adapted to interact with the user devices 110, 180, and 190, and/or the merchant server 120 over the network 160 to facilitate the searching, selection, purchase, payment of items, and/or other services offered by the service provider server 130. In one example, the service provider server 130 may be provided by PayPal, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities (e.g., between two users, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various services provided by the service provider server 130. The interface server 134 may also include other electronic pages associated with the different services (e.g., electronic transaction services, etc.) offered by the service provider server 130. As a result, a user (e.g., the user 140, users of the user devices 180 and 190, or a merchant associated with the merchant server 120, etc.) may access a user account associated with the user and access various services offered by the service provider server 130, by generating HTTP requests directed at the service provider server 130. In some embodiments, the fragment module integration framework may be implemented within or in association with the interface server 134.

The service provider server 130, in one embodiment, may be configured to maintain one or more user accounts and merchant accounts in an account database 136, each of which may be associated with a profile and may include account information associated with one or more individual users (e.g., the user 140 associated with user device 110, users associated with the user devices 180 and 190) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 includes a transaction analysis module 132 that implements the transaction analysis system as discussed herein. The transaction analysis module 132 may access transaction information associated with transactions conducted through user accounts of the online service provider that is stored in the account database 136. Based on the transaction information, the transaction analysis module 132 may identify seed user accounts that satisfy a set of risk criteria, and may generate a tube map for each of the identified seed user accounts. In some embodiments, the transaction analysis module 132 may present the tube map on a display of a computer device, such as the device 150 associated with an agent (e.g., a risk analyst) of the online service provider. In some embodiments, the transaction analysis module 132 may analyze the tube map to determine one or more user accounts that are likely to be involved in illegal activities through the transactions conducted by the one or more user accounts. The transaction analysis module 132 may perform one or more actions on the one or more user accounts.

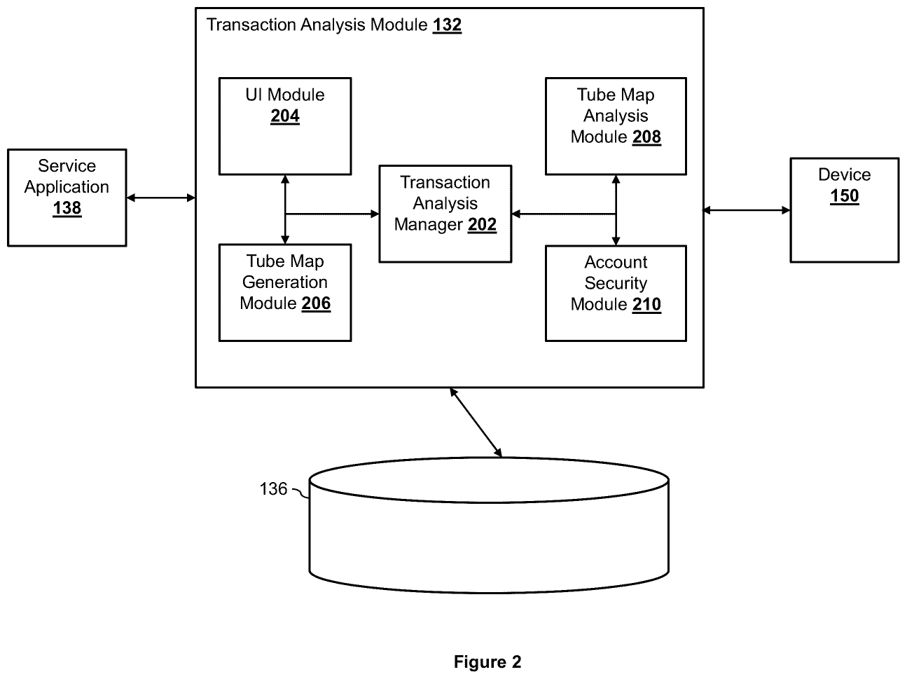

FIG. 2 illustrates a block diagram of the transaction analysis module 132 according to an embodiment of the disclosure. The transaction analysis module 132 includes a transaction analysis manager 202, a user interface (UI) module 204, a tube map generation module 206, a tube map analysis module 208, and an account security module 210. In some embodiments, the transaction analysis manager 202 may be configured to analyze transaction data associated with transactions conducted through user accounts of the online service provider. For example, the transaction analysis manager 202 may analyze the transaction data on a periodic basis (e.g., every day, every week, every month, etc.), in order to identify suspicious activities and/or user accounts that are likely involved in the suspicious activities. Once the user accounts that are likely involved in the suspicious activities are identified, the account security module 210 may perform one or more actions on the identified user accounts. For example, the account security module 210 may lock and/or disable the identified user accounts. The account security module 210 may modify a security setting associated with each of the identified user accounts, such that transactions (or transactions that satisfy a set of risk criteria such as above a predetermined amount, etc.) conducted through the identified user accounts will be denied, and/or additional authentication steps are required to access the identified user accounts.

In some embodiments, the transaction analysis module 132 may detect the suspicious activities and/or the user accounts that are likely involved in the suspicious activities using one or more tube maps that represent various transaction flows within an environment of the online service provider. In this regard, the transaction analysis manager 202 may access transaction data associated with transactions conducted through user accounts with the online service provider from the data storage 136. For example, the transaction analysis manager 202 may retrieve transaction data associated with transactions that were conducted within a time period (e.g., the past six months, the past year, etc.). The transaction analysis manager 202 may then use the tube map generation module 206 to generate one or more tube maps based on the retrieved transaction data.

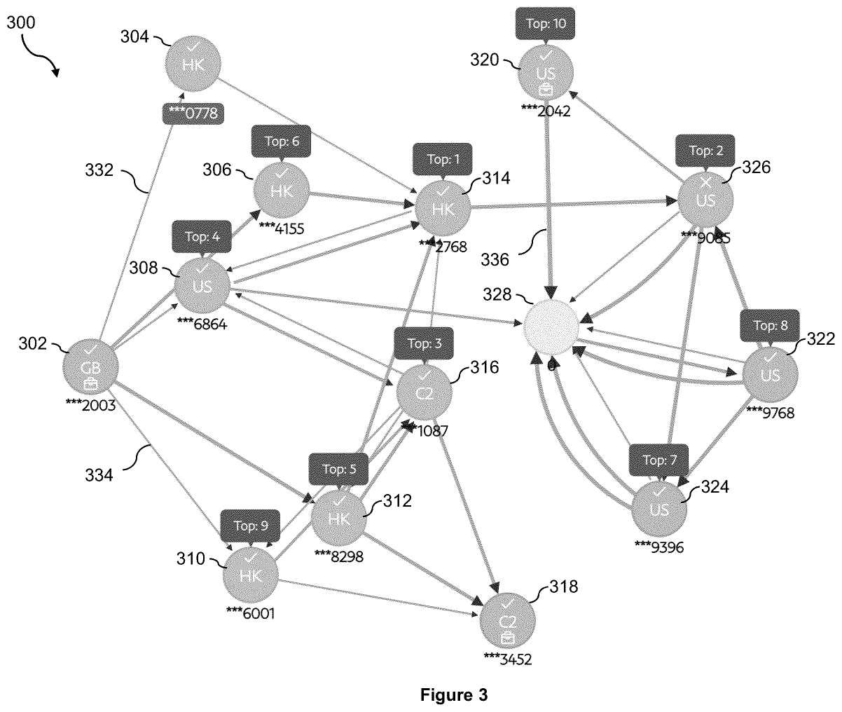

As discussed above, conventional systems may analyze transaction flows within a transaction processing platform using a networked graph that represents transactions among user accounts. The networked graph may be constructed by generating different nodes to represent different user accounts with the online service provider. An edge may be generated between two nodes to represent a transaction conducted between two corresponding user accounts. In some embodiments, the edge may be directional to represent a directional flow of funds associated with the transaction. FIG. 3 illustrates an exemplary networked graph 300 that represents transactions conducted through user accounts with the online service provider. As shown, the networked graph 300 includes nodes 302-326 representing various user accounts with the online service provider. The networked graph 300 may also include an exit node 328 representing a placeholder account (e.g., a fictitious account) where funds is transferred to before being transferred out of the environment of the online service provider (e.g., to another banking institution, etc.).

The networked graph 300 also includes directional edges (e.g., edges 332, 334, 336, etc.). A directional edge from a first node to a second node in the networked graph 300 represents a transaction from a first user account represented by the first node to a second user account represented by the second node. For example, the directional edge 332 that connects from the node 302 to the node 302 may represent a transaction (e.g., a payment transaction, a fund transfer transaction, etc.) between a user account “2003” represented by the node 302 and the user account “0778” represented by the node 304, where funds were transferred from the user account “2003” to the user account “0778.” In another example, the directional edge 336 that connects from the node 320 to the exit node 328 may represent a withdrawal of funds from the user account “2042” represented by the node 320. In this example, different directional edges shown in the networked graph 300 may have different thicknesses. In some embodiments, an amount associated with the transaction may also be represented by a thickness of the direction edge that represents the transaction, such that a thicker direction edge represents a larger amount in a transaction and a thinner direction edge represents a smaller amount in the transaction.

While the networked graph 300 can represent a lot of information associated with transactions that have been conducted through various user accounts with the online service provider, the networked graph 300 can easily become overwhelmingly complex (or even convoluted), as the number of user accounts and/or transactions become large, making it an inefficient medium for viewing and/or analyzing transaction flows. In this example, the networked graph 300 is representing less than forty transactions conducted among thirteen user accounts, which is a very small number and may represent only a small portion (e.g., 1%, 0.1%) of the transactions that have been conducted through the online service provider within a given period (e.g., a day, a week, a month, etc.). However, even with such a small sample of transactions, the networked graph 300 as shown in this example already looks fairly complicated, and transaction flows of particular funds cannot easily be determined based on the graph 300.

For example, the networked graph 300 may represent a transaction flow of particular funds, that were initially transferred from the user account “0778” represented by the node 304 to the user account “2768” represented by the node 314. The particular funds may be split, where a first portion of the funds is transferred from the user account “2768” to the user account “6864” represented by the node 308. A second portion of the funds is transferred from the account “2768” to the user account “9085” represented by the node 326 before being withdrawn through the user account “9085” (as indicated by the edge connecting the node 326 and the exit node 328). The first portion of the funds is transferred from the user account “6864” to the user account “2768” and then back to the user account “6864” before the first portion of the funds is withdrawn through the user account “6864.” While all of the transactions associated with this transaction flow are accurately represented in the networked graph 300, the way that the particular funds are being transferred and/or split among the user accounts (also referred to as the “transaction flow” associated with the particular fund) is not readily apparently from the networked graph 300. For example, it is not readily apparent, from viewing and analyzing the networked graph 300, how many layers of transactions it took before the particular funds are withdrawn from the environment of the online service provider. It is also not readily apparent whether any cyclical payment occurred within the transaction flow based on the networked graph 300.

With such difficulties in analyzing transaction flows using a networked graph that represents a small volume of transactions, one can see that the difficulties would be exponentially increased when analyzing transaction flows using a networked graph that represents a much larger volume of transactions. In particular, the networked graph that represents a larger volume of transactions would become more convoluted, and analyzing any transaction flows within the networked graph would become an impossible task.

Referring back to FIG. 2, as such, instead of, or in addition to, generating a networked graph to represent transactions, the transaction analysis manager 202 may use the tube map generation module 206 to generate one or more tube maps to represent various transaction flows conducted within the environment of the online service provider.

In order to generate one or more tube maps, the tube map generation module may identify, from the user accounts with the online service provider, one or more user accounts that are seed user accounts. In some embodiments, the transaction analysis manager 202 and/or the tube map generation module 206 may define a set of risk criteria for identifying seed user accounts. For example, the transaction analysis manager 202 and/or the tube map generation module 206 may identify seed user accounts based on a number of transactions involved with the seed user accounts and/or an amount of total funds that have been passed through the seed user accounts. Thus, the transaction analysis manager 202 and/or the tube map generation module 206 may determine that a user account is a seed user account when the number of transactions (outgoing and/or incoming) within a particular period (e.g., the last six months, etc.) exceeds a threshold number of transactions and/or the total amount of funds passing through the user account within the particular period exceeds a threshold amount. Since more than one user account may satisfy the set of risk criteria, the transaction analysis manager 202 and/or the tube map generation module 206 may identify multiple seed user accounts.

In some embodiments, the tube map generation module 206 may generate a tube map for each of the identified seed user accounts. For example, the tube map generation module 206 may generate a first tube map based on a first seed user account from the identified seed user accounts. In one example, the first seed user account corresponds to a merchant that has a high volume of transaction flows (e.g., Airbnb®, etc.). The tube map generation module 206 may then access transaction data associated with transactions that flowed through the first seed user account.

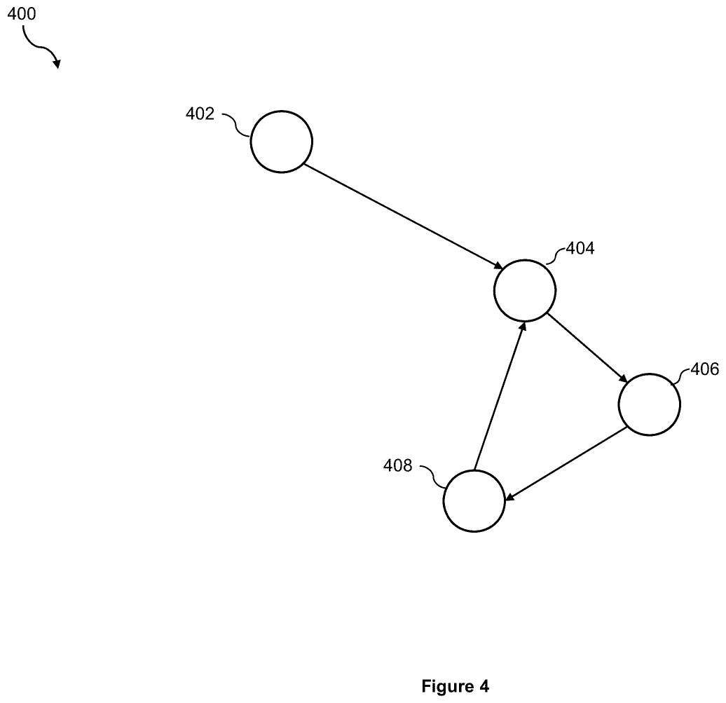

FIG. 4 illustrates a networked graph 400 representing exemplary transactions that flowed through the first seed user account. The networked graph 400 includes nodes 402-408 that represent various user accounts with the online service provider. For example, the node 402 represents the first seed user account, and the nodes 404-408 represent other user accounts with the online service provider that were involved with the transactions. As indicated by the networked graph 400, particular funds were initially transferred from the first seed user account to a user account represented by the node 404. The particular funds were then transferred by the user account represented by the node 404 to a user account represented by the node 406. The particular funds were then transferred by the user account represented by the node 406 to a user account represented by the node 408 before being transferred back to the user account represented by the node 404.

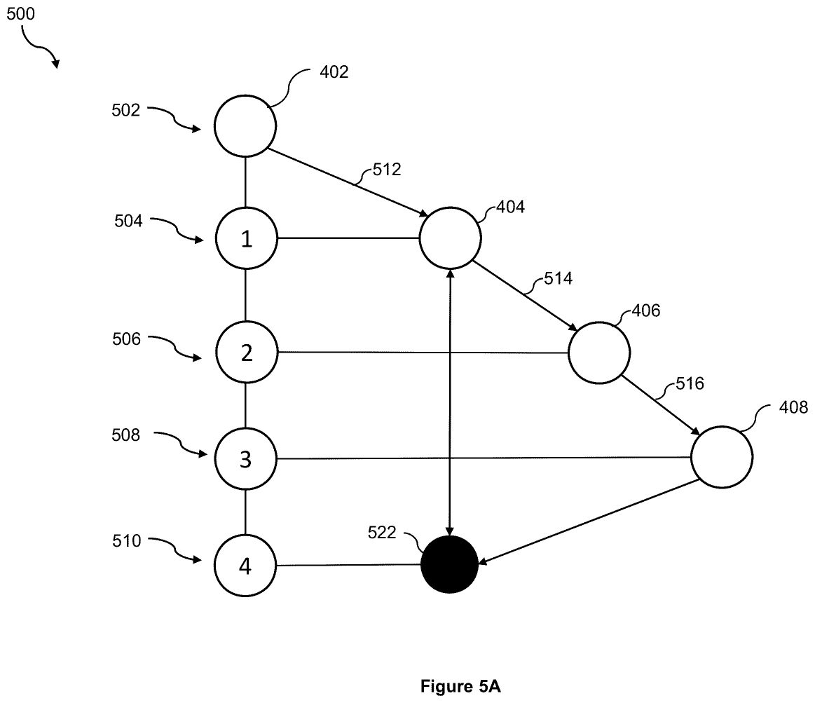

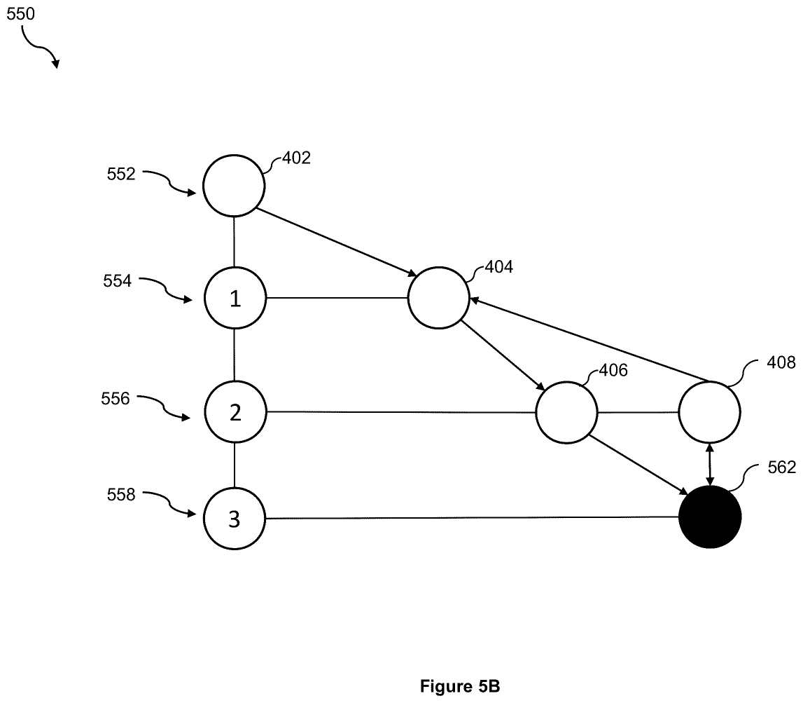

To generate the first tube map, the tube map generation module 206 may generate a seed node (e.g., the node 402) for representing the first seed user account, may dispose the seed node representing the first seed user account in a root tier (a root layer) of the first tube map. FIG. 5A illustrates an example tube map 500 generated by the tube map generation module 206 based on the first seed user account according to one embodiment of the disclosure. As shown, the tube map 500 includes multiple tiers (layers) 502-510 representing different layers of transactions within a transaction flow that flowed through the first seed user account. The tube map generation module 206 may first dispose the seed node 402 representing the first seed user account in the root tier (the root layer) 502 of the tube map 500.

The transaction analysis system may then determine a first set of accounts to which funds are transferred from the first seed user account. In this example, the particular funds were transferred from the first seed user account to the user account represented by the node 404. Thus, the tube map generation module 206 may dispose the node 404 in the first tier (the first layer) 504 of the tube map 500. The transaction associated with transferring the particular funds from the first seed user account to the user account represented by the node 404 may be represented by a directional edge 512 connecting from the seed node 402 in the root tier 502 to the node 404 in the first tier 504.

Similarly, since the particular funds were then transferred from the user account represented by the node 404 to the user account represented by the node 406, the tube map generation module 206 may dispose the node 406 in the second tier (the second layer) 506 of the tube map 500. The transaction associated with transferring the particular funds from the user account represented by the node 404 to the user account represented by the node 406 may be represented by a directional edge 514 connecting from the node 404 in the first tier 504 to the node 406 in the second tier 506.

Since the particular funds were then transferred from the user account represented by the node 406 to the user account represented by the node 408, the tube map generation module 206 may dispose the node 408 in the third tier (the third layer) 508 of the tube map 500. The transaction associated with transferring the particular funds from the user account represented by the node 406 to the user account represented by the node 408 may be represented by a directional edge 516 connecting from the node 406 in the second tier 506 to the node 408 in the third tier 508.

The particular funds were then transferred back from the user account represented by the node 408 to the user account represented by the node 404. Since the transaction from the user account represented by the node 408 to the user account represented by the node 404 creates a new layer of transaction, the tube map generation module 206 may create a new fourth tier 510 in the tube map 500 for this transaction. In some embodiments, the tube map generation module 206 may also create a new node 522 for representing the same user account represented by the node 404 to be disposed in the fourth tier 510 in the tube map 500. By using different tiers (layers) in the tube map 500 to represent different transaction layers within the transaction flow (e.g., every time funds are being transferred from user account(s) in the previous tier), the tube map 500 can clearly illustrate the different layers of transactions within the transaction flow, which cannot be achieved using a conventional networked graph.

Thus, the tube map generation module 206 may generate a new node (e.g., the node 522) for the user account (even though the user account is also represented by another node 404), and may dispose the new node 522 in a new tier (e.g., the tier 510) to represent the transaction from the user account represented by the node 408 to the user account represented by 404. Since the node 522 in the tier 510 represents the same user account as a node (e.g., the node 404) in a previous tier 504, the tube map generation module 206 may provide a different designation for the node 522. For example, the tube map generation module 206 may designate the node 522 as a shadow node based on the node 522 representing the same user account as another node 404 in a previous tier 504.

While the tube map 500 is shown to have only five tiers and one shadow node, it is conceivable that a tube map that represents a more complex transaction flow would have additional tiers and/or shadow nodes. As discussed herein, the different tiers within the tube map 500 enable quick detection (e.g., by a human analyzer viewing the tube map 500 or a computer analyzing the tube map 500, etc.) of the number of transaction layers associated with a transaction flow (e.g., a number of hops that particular funds have gone through before exiting the environment of the online service provider). Similarly, the specially designated shadow nodes enable quick detection of cyclical payments involved in the transaction flow. Specifically, each shadow node indicates a distinct cyclical payment that involves funds that have been transferred out from a particular user account are subsequently transferred back to the particular user account. Thus, the transaction analysis module 132 may detect patterns that involve suspicious transaction activities using the tube map data structure as disclosed herein more efficiently than using conventional networked graphs.

FIG. 5B illustrates an alternative way of constructing a tube map 550 according to various embodiments of the disclosure. As shown, the tube map 550 also includes multiple tiers (layers) 552-558 representing different transaction layer of a transaction flow associated with the first seed user account. Similar to the tube map 500, the tube map generation module 206 may dispose the seed node 402 representing the first seed user account in the root tier 552 of the tube map 550. Based on the transaction that transfers the particular funds from the first seed user account to the user account represented by the node 404, the tube map generation module 206 may dispose the node 404 in the first tier 554 of the tube map 550. Similarly, based on the transaction that transfers the particular funds from the user account represented by the node 404 to the user account represented by the node 406, the tube map generation module 206 may dispose the node 406 in the second tier 556 of the tube map 550.

The particular funds are then transferred from the user account represented by the node 406 to the user account represented by the node 408, before being transferred back to the user account represented by the node 404. Instead of disposing the node 408 in the third tier 558, the tube map generation module 206 may generate a new node 562 (which may be designated as a shadow node as discussed herein) for representing the user account that is also represented by the node 408. The tube map generation module 206 may dispose the shadow node 562 in the third tier 558, and dispose the other node 408 that represents the same user account in the second tier 556 for the transaction that transfers the particular funds back to the user account represented by the node 404.

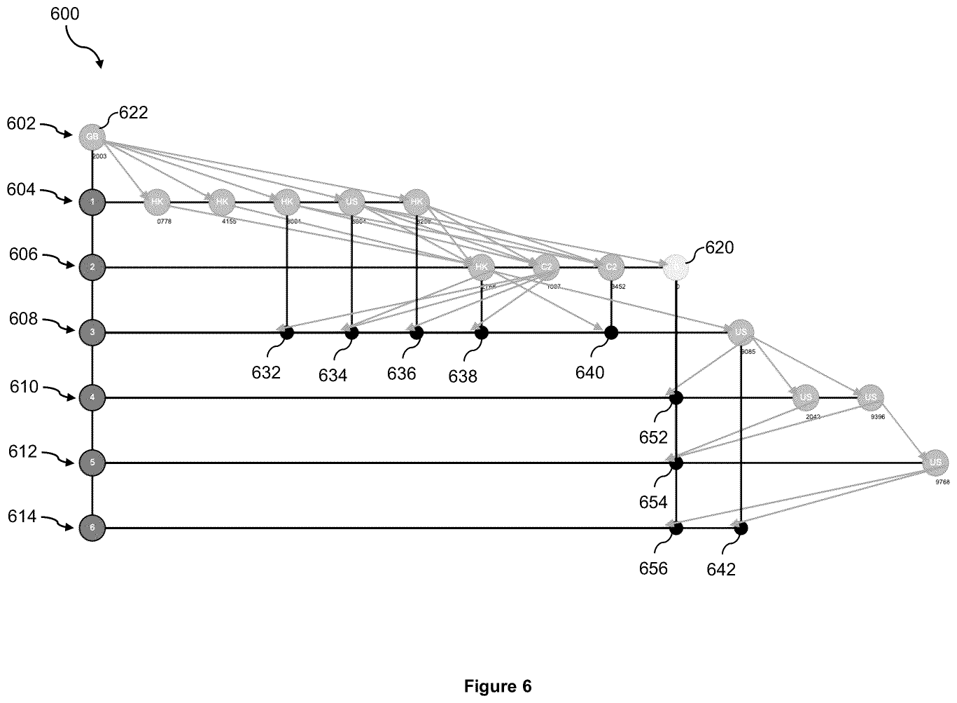

In some embodiments, the tube map generation module 206 may also include an exit node in the tube map to show how funds that are involved a transaction flow exits the environment of the online service provider (e.g., being withdrawn to another banking institute, etc.). In some embodiments, the tube map generation module 206 may dispose an exit node in the tube map (e.g., in any one of the tiers or layers in the tube map). The tube map may then connect nodes (e.g., using a directional edge, etc.) representing user accounts from which funds are withdrawn to the exit node. FIG. 6 illustrates another exemplary tube map 600 that includes an exit node. In some embodiments, the tube map 600 may be generated by the tube map generation module 206 to represent a transaction flow associated with a seed user account (e.g., a second seed user account) with the online service provider. As shown, the tube map generation module 206 may generate a node 622 to represent the second seed user account, and may dispose the node 622 in the root tier 602 of the tube map 600. By tracing transactions within the transaction flow that originated from the second seed user account, the tube map generation module 206 may generate additional nodes that represent different user accounts involved in the transaction flow, and may dispose the nodes in the tiers 604-614 of the tube map based on their corresponding layer of transaction within the transaction flow. The tube map may also generate direction edges that connect nodes to represent transactions conducted between the user account represented by the nodes, as shown in the figure. In some embodiments, the tube map generation module 206 may also generate an exit node 620 that represents a placeholder account (e.g., a fictitious account) for funds being withdrawn from one or more user accounts with the online service provider. When funds are withdrawn from a particular user account, a connection may be placed in the tube map 600 connecting a node representing the particular user account to the exit node 620.

As discussed herein, when a user account is involved in multiple transactions in different layers, shadow nodes may be generated for those accounts. As shown in the tube map 600, six of the user accounts are involved in multiple transactions in different layers within the transaction flow, as indicated by the six shadow nodes 632-642 created for those user accounts. In some embodiments, the tube map generation module 206 may also create shadow nodes 652-656 for the exit node 620 such that the placeholder account can exist in multiple tiers in the tube map when funds are being withdrawn from different transaction layers within the transaction flow transaction layers within the transaction flow.

In some embodiments, once a tube map is generated by the tube map generation module 206, the transaction analysis manager 202 may use the UI module 204 to present the tube map in a graphical user interface on a device that is coupled to the service provider server 130, such as the device 150. The device 150 may be associated with an agent of the online service provider (e.g., risk analyst, etc.). In some embodiments, the tube map presentation that is displayed on the device 150 may be interactive. For example, the tube map may be presented initially on the user device with only the nodes in the different tiers, without the edges, such that the tube map does not look cluttered. Since the tube map presents the nodes in different tiers that correspond to the different transaction layers within a transaction flow, the transaction structure of the transaction flow, such as how funds are being transferred among the user accounts, and how many times the funds are being transferred among the user accounts before they are withdrawn, etc., can be apparent just by viewing the tube map without the edges.

In some embodiments, each of the nodes in tube map presented on the device 150 is selectable. Upon receiving a selection of a node, the UI module 204 may present, on the device 150, the edges that are connected to the node. In some embodiments, each of the edges presented on the device 150 may also be selectable. Upon receiving a selection of an edge, the UI module 204 may present information associated with the corresponding transaction (e.g., an amount, a date, etc.).

In some embodiments, the transaction analysis manager 202 may use the tube map analysis module 208 to analyze a transaction flow using the tube map generated for the transaction flow. For example, the tube map analysis module 208 may determine whether any portions of the transaction flow match a pattern corresponding to malicious activities. In some embodiments, the tube map analysis module 208 may use the tube map to identify user accounts that are involved in a cyclical payment. By accessing the tube may (e.g., the tube map 500, the tube map 550, the tube map 600, etc.), the tube map analysis module 208 may first determine whether any shadow node exists. Since each shadow node corresponds to a distinct cyclical payment pattern, the tube map analysis module 208 may identify cyclical payments within the transaction flow based on the shadow node(s) identified within the tube map.

For example, within the tube map 500, the tube map analysis module 208 may determine that a cyclical payment exists based on the shadow node 522. In another example, the tube map analysis module 208 may determine that there are six cyclical payments within the transaction flow based on the six shadow nodes 632-642 within the tube map 600. For each shadow node within the tube map, the tube map analysis module 208 may identify nodes that are part of a payment cycle based on traversing the tube map forward and/or backward from the shadow node. For example, the tube map analysis module 208 may traverse forward and/or backward from the shadow node 522 in the tube map 500, and identify the nodes 404, 406, and 408 as part of the cyclical payment pattern associated with the shadow node 522. Once the nodes that are part of the payment cycle are identified, the tube map analysis module 208 may label the user account(s) corresponding to the identified nodes as high risk user accounts.

In some embodiments, the tube map analysis module 208 may also use the tube map to identify user accounts being used by malicious users for funneling funds out of the environment of the online service provider. The tube map analysis module 208 may first identify an exit node within the tube map (e.g., the exit node 620 in the tube map 600), and determine a first group of nodes that are connected to the exit node. For example, the tube map analysis module 208 may determine nodes in the tube map 600 that are directed connected to the exit node 620. The first group of nodes that are connected to the exit node represents user accounts through which funds have been withdrawn from the environment of the online service provider. Since malicious users may use dummy user accounts for withdrawing funds to evade detection, the tube map analysis module 208 of some embodiments may backward-trace the withdrawn funds through the identified user accounts by traversing the tube map backward from the first group of nodes that are connected to the exit node.

Based on the traversing of the tube map, the tube map analysis module 208 may determine a second group of nodes that provide funds to the first group of nodes for withdrawal. In some embodiments, the tube map analysis module 208 may analyze the transactions between the second group of nodes and the first group of nodes. In some embodiments, the tube map analysis module 208 may label one or more user accounts corresponding to the second group of nodes based on the transactions. For example, when a total transaction amount associated with one or more transactions from a user account corresponding to one of the second group of nodes to one or more user accounts corresponding to one or more of the first group of nodes exceeds a threshold amount, the tube map analysis module 208 may label the user account corresponding to the one of the second group of nodes as a high risk user account.

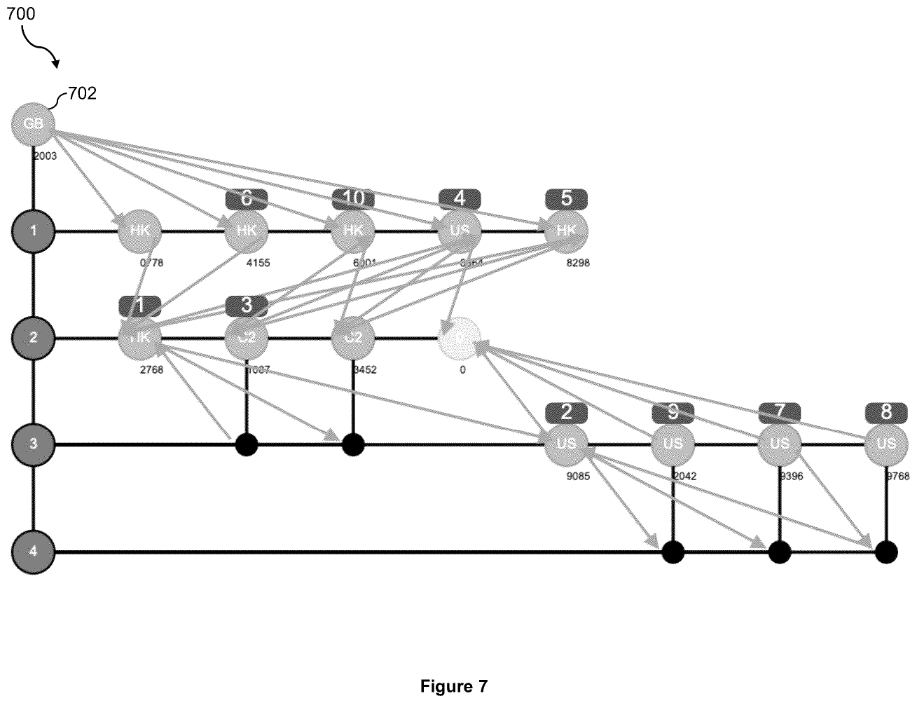

In some embodiments, the tube map analysis module 208 may determine a risk profile for each node within the tube map based on the analyzing of the tube map as discussed herein. For example, the tube map analysis module 208 may increase a risk profile of a node if the node is part of a cyclical cycle associated with a shadow node in the tube map. The tube map analysis module 208 may also increase a risk profile of a node if the node provides funds to another node for withdrawal. The tube map analysis module 208 may then rank the nodes within the tube map based on their risk profiles. FIG. 7 illustrates a tube map 700 generated by the tube map generation module 206 to represent a transaction flow based on a seed user account represented by a node 702. The tube map analysis module 208 may analyze the tube map 700 using the techniques disclosed herein to determine a risk profile for each of the nodes in the tube map 700. The tube map analysis module 208 may also rank at least some of the nodes in the tube map 700 based on their risk profiles. As shown, the tube map analysis module 208 has ranked the top ten nodes with the highest risk among the nodes in the tube map 700 based on their risk profiles.

In some embodiments, the transaction analysis module 132 may continue to generate, present, and analyze tube maps that are based on other seed user accounts to identify high risk user accounts. Using the tube maps (instead of or in addition to the conventional networked graph), collective transactions within one or more transaction flows can be analyzed more efficiently. Thus, suspicious activities and suspicious user accounts can be detected faster than using conventional methods. Actions to protect the transaction processing platform and user accounts with the online service provider can be performed more swiftly based on the identified suspicious activities to avoid further loses or damages associated with the transaction processing platform. In some embodiments, once the high risk user accounts are identified, the transaction analysis manager 202 may use the account security module 210 to perform one or more actions on the high risk user accounts. For example, the account security module 210 may cause the service application 138 to increase a security setting associated with the high risk user accounts, such as denying transactions conducted through the high risk user accounts, limited a number of transactions being conducted through the high risk user accounts, etc.

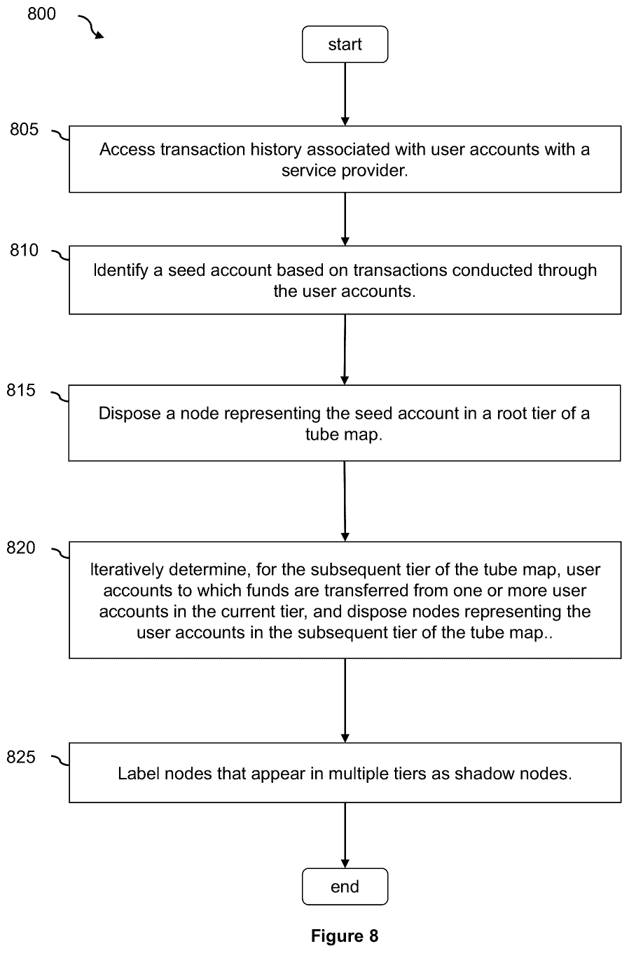

FIG. 8 illustrates a process 800 for generating a tube map according to various embodiments of the disclosure. In some embodiments, at least a portion of the process 800 may be performed by the transaction analysis module 132. The process 800 may begin by accessing (at step 805) transaction history associated with user accounts with a service provider. For example, the transaction analysis manager 202 may access transaction data related to transactions conducted by user accounts of the online service provider in the database 136. In one example, the transaction analysis manager 202 may access only transaction data that satisfies a set of criteria such as a time criterion (e.g., within a specific period of time, etc.).

The process 800 then identifies (at step 810) a seed account based on transactions conducted through the user accounts. For example, the tube map generation module 206 may determine that a user account with the online service provider is a seed user account when a number of transactions conducted through the user account exceeds a threshold number and/or an amount involved in the transactions conducted through the user account exceeds a threshold amount. The tube map generation module 206 may generate a tube map for each of the identified seed user accounts.

The process 800 then disposes (at step 815) a node representing the seed account in a root tier of a tube map and iteratively determines (at step 820), for the subsequent tier of the tube map, user accounts to which funds are transferred from one or more user accounts in the current tier, and disposes nodes representing the user accounts in the subsequent tier of the tube map. For example, the tube map generation module 206 may generate a node for representing the seed user account, and may dispose the node at a root tier of a tube map. The tube map generation module 206 may then determine a first set of user accounts to which funds are being transferred from the seed user account. The tube map generation module 206 may generate a first set of nodes for representing the first set of user accounts, and dispose the first set of nodes in the first tier of the tube map. The tube map generation module 206 may then determine a second set of user accounts to which funds are being transferred from the first set of user account. The tube map generation module 206 may generate a second set of nodes for representing the second set of user accounts, and dispose the second set of nodes in the second tier of the tube map. The tube map generation module 206 may continue to trace the funds based on the transaction data, and add nodes to subsequent tiers in the tube map until the funds are being withdrawn.

For example, the tube map generation module 206 may generate an exit node representing a placeholder account through which funds exit the environment of the online service provider. The tube map generation module 206 may connect the nodes representing the user accounts through which funds are withdrawn to the exit node in the tube map.

The process 800 then labels (at step 825) nodes that appear in multiple tiers as shadow nodes. For example, when the tube map generation module 206 determines that a node that represents a user account is also represented by another node in one or more previous tiers, the tube map generation module 206 may designate the node as a shadow node, and create a connection between the nodes that represent the same user account.

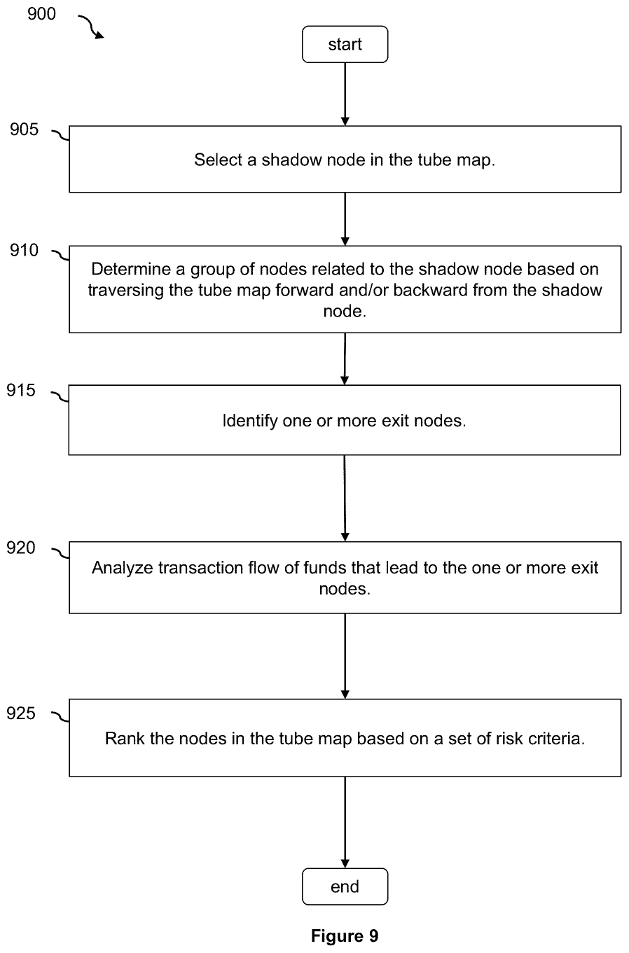

FIG. 9 illustrates a process 900 for analyzing a tube map according to various embodiments of the disclosure. In some embodiments, at least a portion of the process 900 may be performed by the transaction analysis module 132. The process 900 may begin by selecting (at step 905) a shadow node in the tube map. For example, the tube map analysis module 208 may access a tube map generated by the tube map generation module 206. The tube map may be generated to represent transaction flows based on a particular seed user account. As discussed herein, the tube map generation module 206 may generate and dispose a shadow node in the tube map when the same user account is involved in multiple layers of transactions. As such, the tube map that is generated may include one or more shadow nodes. Each of the shadow nodes may correspond to a distinct cyclical payment. The tube map analysis module 208 may select a first one of the one or more shadow nodes to analyze a corresponding cyclical payment.

After selecting a shadow node, the process 900 determines (at step 910) a group of nodes related to the shadow node based on traversing the tube map forward and/or backward from the shadow node. For example, the tube map analysis module 208 may traverse the tube map forward and/or backward from the selected shadow node. Since the shadow node indicates a cyclical payment pattern, traversing the tube map forward or backward from the shadow node should end up back in the shadow node. The tube map analysis module 208 may determine the nodes it passes through as it traverses the tube map from the shadow node in a direction (e.g., backward or forward). In some embodiments, the tube map analysis module 208 may modify the risk profiles of the user accounts corresponding to the nodes based on their association with this cyclical payment pattern. For example, the tube map analysis module 208 may increases a risk level for each of the user accounts corresponding to the nodes. In some embodiments, when there are multiple shadow nodes in the tube map, the tube map analysis module 208 may continue to select another shadow node and perform the same analysis based on the other shadow node until all of the shadow nodes in the tube map have been analyzed.

The process then identifies (at step 915) one or more exit node and analyzes (at step 920) transaction flow of funds that lead to the one or more exit nodes. As discussed herein, the tube map generation module 206 may generate one or more exit nodes and dispose the one or more exit nodes in one or more tiers of the tube map. An exit node represents a placeholder account (or a fictitious account) through which funds are being withdrawn from the environment of the online service provider. As such, when a withdrawal transaction is performed through a user account, the tube map generation module 206 may connect a node representing the user account to an exit node in the tube map.

Thus, the tube map analysis module 208 may identify an exit node in the tube map, and may analyze the connection that leads to the exit node, which represents the transactions that lead to the withdrawal of funds. For example, the tube map analysis module 208 may identify a first group of user accounts that withdraw funds from the environment of the online service provider (e.g., withdraw the funds to an external banking institute, etc.), and may identify a second group of user accounts that provide the funds for withdrawal to the first group of user accounts based on traversing the tube map backward from the exit node. The tube map analysis module 208 may modify risk profiles of the first and/or second group of user accounts (e.g., increasing the risk levels associated with those user accounts). In some embodiments, the tube map analysis module 208 may modify the risk profiles differently for the first and/or second group of user accounts based on the total amount of funds involved in the transactions and/or the total number of transactions conducted through the user accounts. For example, a higher risk would be assigned to a user account when the amount of funds conducted through the user account that leads to the withdrawal is larger, and a lower risk would be assigned to a user account when the amount of funds conducted through the user account that leads to the withdrawal is smaller.

The process 900 then ranks (at step 925) the nodes in the tube map based on a set of risk criteria. For example, the tube map analysis module 208 may rank at least some of the nodes in the tube map based on the risk profiles, after their risk profiles are determined or modified during the analysis process. In some embodiments, the UI module 204 may present the ranking on the device (e.g., the device 150), for example, upon receiving a risk ranking request via a user interface presented on the device. In some embodiments, the ranking may be used by the tube map analysis module 208 and/or the service application 138 to perform an action to the user accounts represented by the nodes (e.g., blocking the account, denying transactions from the account, etc.).

While the tube map has been described above to trace transfer of funds (e.g., fiat currency, crypto-currency, etc.), it can also be used to detect malicious activities in other settings such as within a social network. In this example, the tube map may be used to trace interactions among user accounts within a social network (e.g., connections such as relationships among user accounts, messaging among the user accounts, transfer of images or other data among the user accounts, etc.). By detecting patterns of interactions among user accounts of the social network, the system may identify malicious user accounts involved in the malicious activities, and may be able to perform actions on the user accounts to prevent losses or damages to an electronic network associated with the social network.

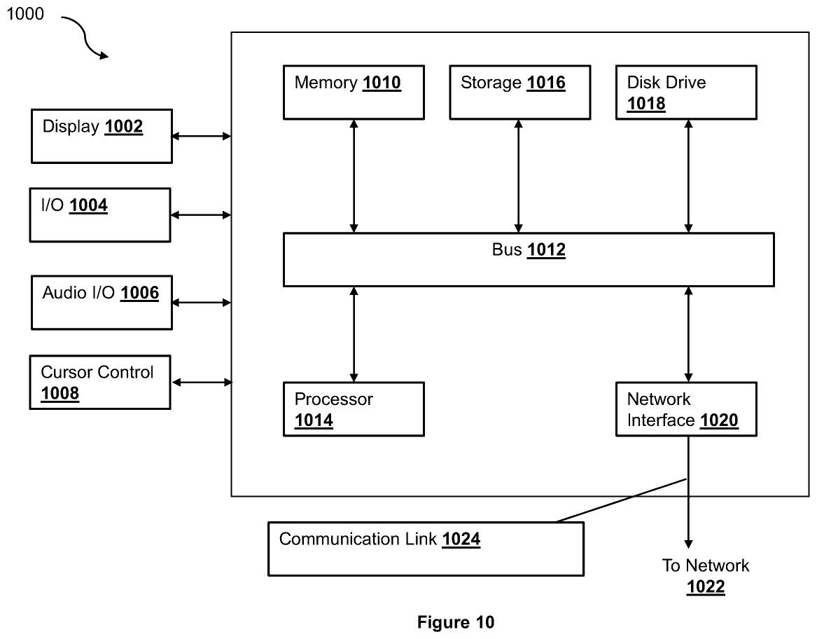

FIG. 10 is a block diagram of a computer system 1000 suitable for implementing one or more embodiments of the present disclosure, including the service provider server 130, the merchant server 120, the user devices 110, 180, and 190, and the device 150. In various implementations, each of the devices 110, 150, 180, and 190 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices/servers 110, 120, 130, 150, 180, and 190 may be implemented as the computer system 1000 in a manner as follows.

The computer system 1000 includes a bus 1012 or other communication mechanism for communicating information data, signals, and information between various components of the computer system 1000. The components include an input/output (I/O) component 1004 that processes a user (i.e., sender, recipient, service provider) action, such as selecting keys from a keypad/keyboard, selecting one or more buttons or links, etc., and sends a corresponding signal to the bus 1012. The I/O component 1004 may also include an output component, such as a display 1002 and a cursor control 1008 (such as a keyboard, keypad, mouse, etc.). The display 1002 may be configured to present a login page for logging into a user account or a checkout page for purchasing an item from a merchant. An optional audio input/output component 1006 may also be included to allow a user to use voice for inputting information by converting audio signals. The audio I/O component 1006 may allow the user to hear audio. A transceiver or network interface 1020 transmits and receives signals between the computer system 1000 and other devices, such as another user device, a merchant server, or a service provider server via a network 1022, such as network 160 of FIG. 1. In one embodiment, the transmission is wireless, although other transmission mediums and methods may also be suitable. A processor 1014, which can be a micro-controller, digital signal processor (DSP), or other processing component, processes these various signals, such as for display on the computer system 1000 or transmission to other devices via a communication link 1024. The processor 1014 may also control transmission of information, such as cookies or IP addresses, to other devices.

The components of the computer system 1000 also include a system memory component 1010 (e.g., RAM), a static storage component 1016 (e.g., ROM), and/or a disk drive 1018 (e.g., a solid-state drive, a hard drive). The computer system 1000 performs specific operations by the processor 1014 and other components by executing one or more sequences of instructions contained in the system memory component 1010. For example, the processor 1014 can perform the tube map generation and analysis functionalities described herein according to the processes 800 and 900.

Logic may be encoded in a computer readable medium, which may refer to any medium that participates in providing instructions to the processor 1014 for execution. Such a medium may take many forms, including but not limited to, non-volatile media, volatile media, and transmission media. In various implementations, non-volatile media includes optical or magnetic disks, volatile media includes dynamic memory, such as the system memory component 1010, and transmission media includes coaxial cables, copper wire, and fiber optics, including wires that comprise the bus 1012. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 1000. In various other embodiments of the present disclosure, a plurality of computer systems 1000 coupled by the communication link 1024 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
identifying, from a plurality of user accounts with a service provider, a first user account based on a set of risk criteria;
generating a tube map for tracing funds that flowed through the first user account, wherein the tube map comprises a plurality of tiers of nodes, and wherein the generating the tube map comprises:
disposing a seed node representing the first user account in a root tier of the plurality of tiers in the tube map, and
iteratively determining a set of user accounts to which portions of the funds were transferred from one or more user accounts represented by one or more nodes in a current tier in the tube map, and disposing a set of nodes representing the set of user accounts in a subsequent tier of the plurality of tiers in the tube map;
detecting one or more patterns corresponding to fraudulent activities based on analyzing positions of the nodes in the plurality of tiers in the tube map;
identifying one or more high-risk user accounts with the service provider that are likely involved in suspicious activities based on the detecting; and
performing one or more actions to the one or more high-risk user accounts.

2. The system of claim 1, wherein the generating the tube map further comprises:
determining whether a first node in a first tier of the tube map represents a second user account that is also represented by a second node in a second tier in the tube map; and
in response to determining that the first node in the tube map represents the second user account that is also represented by the second node in the tube map, labeling the first node as a shadow node.

3. The system of claim 2, wherein the detecting the one or more patterns comprises:
identifying a first shadow node within the tube map;
traversing the tube map in a particular direction from the first shadow node; and
identifying a group of user accounts involved in a cyclical payment pattern based on the traversing.

4. The system of claim 3, wherein the operations further comprise:
modifying risk profiles associated with the group of user accounts based on the group of user accounts involved in the cyclical payment pattern.

5. The system of claim 1, wherein the generating the tube map further comprises:
disposing an exit node in the tube map;
identifying nodes in the tube map representing user accounts through which withdrawal transactions have been conducted; and
connecting the identified nodes to the exit node in the tube map.

6. The system of claim 5, wherein the detecting the one or more patterns comprises:
traversing the tube map in a backward direction from the exit node;
identifying user accounts that provide funds for withdrawal based on the traversing; and
modifying risk profiles associated with the identified user accounts.

7. The system of claim 1, wherein the operations further comprise:
determining, for each node in the tube map, a risk profile based on a number of transactions conducted through a corresponding user account and/or a total amount of funds associated with the transactions conducted through the corresponding user account.

8. A method, comprising:
determining, by one or more hardware processors from a plurality of user accounts with a service provider, a seed user account based on a set of risk criteria;
accessing, by the one or more hardware processors, a tube map corresponding to the seed user account, wherein the tube map represents a transaction flow associated with transactions originated from the seed user account, wherein the tube map comprises a plurality of tiers of nodes, and is generated by:
disposing a seed node representing the seed user account in a first tier of the plurality of tiers in the tube map, and
iteratively determining a set of user accounts to which funds were transferred from one or more user accounts represented by one or more nodes in a current tier in the tube map, and disposing a set of nodes representing the set of user accounts in a subsequent tier of the plurality of tiers in the tube map;
analyzing relationships among nodes in different tiers within the tube map;
determining one or more user accounts with the service provider that exceed a fraudulent activity threshold based on the analyzing; and
performing one or more actions to the one or more user accounts.

9. The method of claim 8, further comprising:
presenting, on a user device, a graphical representation of the tube map.

10. The method of claim 9, wherein the graphical representation of the tube map is presented without displaying edges connecting the nodes, and wherein the method further comprises:
receiving a selection of a particular node in the tube map; and
presenting, on the user device, one or more edges connecting the particular node with one or more nodes in the tube map, wherein the one or more edges represent transactions conducted between a user account represented by the particular node and one or more user accounts represented by the one or more nodes.

11. The method of claim 8, further comprising:
determining a risk profile for each node in the tube map based on the analyzing; and
ranking at least a portion of the nodes in the tube map based on the risk profiles.

12. The method of claim 11, further comprising:
presenting the ranking on the user device.

13. The method of claim 8, wherein the tube map is generated further by:
determining whether a first node in in a first tier of the tube map represents a particular user account that is also represented by a second node in a second tier in the tube map; and
in response to determining that the first node in the tube map represents the particular user account that is also represented by the second node in the tube map, labeling the first node as a shadow node.

14. The method of claim 13, wherein the analyzing relationships among nodes in different tiers within the tube map comprise:
identifying a first shadow node within the tube map;
traversing the tube map in a particular direction from the first shadow node; and
identifying a group of user accounts involved in a cyclical payment pattern based on the traversing.

15. A non-transitory machine-readable medium having stored thereon machine-readable instructions executable to cause a machine to perform operations comprising:
identifying, from a plurality of user accounts with a service provider, a seed user account based on a set of risk criteria;
generating a tube map for tracing funds that flowed through the seed user account, wherein the tube map comprises a plurality of tiers of nodes, and wherein the generating the tube map comprises:
disposing a seed node representing the seed user account in a root tier of the plurality of tiers in the tube map, and
iteratively determining a set of user accounts to which portions of the funds were transferred from one or more user accounts represented by one or more nodes in a current tier in the tube map, and disposing a set of nodes representing the set of user accounts in a subsequent tier of the plurality of tiers in the tube map;
analyzing relationships among the nodes from different tiers of the tube map;
determining risk profiles for user accounts represented by the nodes in the tube map based on the analyzing; and
performing one or more actions to at least one of the user accounts represented by the nodes in the tube map based on the risk profiles.

16. The non-transitory machine-readable medium of claim 15, wherein the generating the tube map further comprises:
generating an edge that connects two nodes in the tube map based on a transaction conducted between two user accounts represented by the two nodes.

17. The non-transitory machine-readable medium of claim 15, wherein the operations further comprise:
presenting, on a user device, a graphical representation of the tube map.

18. The non-transitory machine-readable medium of claim 17, wherein the graphical representation of the tube map is presented without displaying edges connecting the nodes, and wherein the operations further comprise:
receiving a selection of a particular node in the tube map; and
presenting, on the user device, one or more edges connecting the particular node with one or more nodes in the tube map, wherein the one or more edges represent transactions conducted between a user account represented by the particular node and one or more user accounts represented by the one or more nodes.

19. The non-transitory machine-readable medium of claim 17, wherein the operations further comprise:
receiving a selection of a particular edge in the tube map; and
presenting, on the user device, information associated with a transaction represented by the particular edge, wherein the information comprises at least a transaction date and an amount.

20. The non-transitory machine-readable medium of claim 17, wherein the operations further comprise:
ranking the nodes in the tube map based on the corresponding risk profiles; and
presenting the ranking on the user device.
